(19) United States
(12) Patent Application Publication
(10) Pub. No.: US 2022/0017245 A1
(43) Pub. Date: Jan. 20, 2022

(54) A PRINTING SYSTEM

(71) Applicant: Tetra Laval Holdings & Finance S.A., Pully (CH)

(72) Inventors: Sverker Olsson, Sondra Sandby (SE); Sylvian Debaecker, Eslov (SE)

(21) Appl. No.: 17/309,667

(22) PCT Filed: Nov. 25, 2019
(86) PCT No.: PCT/EP2019/082409

§ 371 Date: Jun. 14, 2021

(30) Foreign Application Priority Data
Dec. 18, 2018 (EP) 18213253.0

(51) Int. Cl. B65B 9/20; B65B 31/02; B65B 51/26

(52) U.S. Cl. CPC B65B 9/2014; B65B 51/26; B65B 31/021

(57) ABSTRACT

A printing system to be used in a filling machine (20) for printing to a web of packaging material (2) is provided. The printing system (1) comprises a primary roller (10) configured to guide the web of packaging material (2) along its surface, and at least one printing head (4) configured to discharge a colouring substance onto the web of packaging material (2) as it is guided by the primary roller (10). The primary roller (10) further comprises at least one heating element (12) for controlling the radius of the primary roller (10).

### TECHNICAL FIELD

The invention relates to a printing system to be used in a filling machine to print a web of packaging material and a method thereof. The invention further relates to a primary roller of said printing system and use of said primary roller in a printing system.

### BACKGROUND ART

Packaging material used to form individual packages, e.g. suitable for enclosing liquid food, normally has a décor on the outer surface for providing an aesthetically appealing appearance of the package, as well as providing information to the customer relating to content, etc.

Such décor is usually provided in a converting process, i.e. during the process when the packaging material is formed during lamination of a core layer, such as a carton-based layer. This means that the décor is already provided on the packaging material when the packaging material is fed to the filling machine.

In liquid food packaging, the filling machine receives a continuous web of packaging material. When transported through the filling machine, the packaging material is sterilized, formed into a tube, filled with content, formed into a three-dimensional package, sealed, and cut to individual packages separate from the upstream tube.

Recent developments have suggested the use of providing additional information to the packaging material as the packaging material is transported through the filling machine. Such information may be of purely aesthetical character, or it may be readable data corresponding to machine parameters, such as production date, production facility, etc. In other cases, the additional information may be for machine use only, e.g. providing reference marks for downstream operations of the filling machine.

For providing such additional information it has been suggested to use inkjet technology, which is based on droplets of different colours being discharged from a printing nozzle onto a substrate, such as the web of packaging material described above. A printing system using inkjet technology comprises several printing heads, each having a specific colour of a certain colour model, and each printing head having a large number of individually controlled printing nozzles. A commonly used colour model is CMYK (cyan, magenta, yellow, black). The four colours of the colour model are combined to yield a multicolour print.

To ensure a satisfying printing result, it is important to control the distance between each of the printing heads and the web of packaging material. Since the position of the printing heads is normally fixed, while the web of packaging material is running at a very high speed, the position of the web in relation to the printing heads have to be controlled, especially in the normal direction of the packaging material.

This is not easily solved. Variations in packaging material thickness may be caused by storage conditions such as humidity and/or temperature.

A fluctuation in the tension of the web of packaging material when running through the filling machine can also induce changes in the normal distance between the web and the printing heads. Vibrations of the web is yet another complication, which can yield inaccurate prints and undesired results.

In addition to the above problems, different types of packaging material may have different thickness. If the filling machine is producing a first type of package from a first type of packaging material, which is later changed to a second type of package from a second type of packaging material having a different thickness, there is a risk that the print result will be unsatisfactory unless adjustments are made.

It is therefore desired to provide a printing system for a filling machine, which allows for improved printing results.

### SUMMARY

It is an object of the invention to at least partly overcome one or more of the above-identified limitations of the prior art. In particular, it is an object to improve the quality of printing results of a printing system for a filling machine by controlling the positioning of the web of packaging material used in relation to at least one printing head.

The present disclosure is based—inter alia—on the idea that a radius of a primary roller in a printing system to be used in a filling machine may be adjusted by using heating element(s) within the primary roller itself. The heating element(s) causes thermal expansion of the primary roller which in turn causes the radius to increase. Printing head(s) in the printing system are fixed relative a centre of the primary roller. A distance between the surface of a packaging material, which is to be printed when being threaded around said primary roller, and the printing head(s) discharging colouring substance onto the packaging material, may therefore be controlled. This improves printing quality of the printing system since the system can compensate for differences in thicknesses of the web of packaging material.

In a first aspect, there is provided a printing system to be used in a filling machine for printing to a web of packaging material. The printing system comprises a primary roller configured to guide the web of packaging material along its surface, and at least one printing head configured to discharge a colouring substance onto the web of packaging material as it is guided by the primary roller. The primary roller further comprises at least one heating element for controlling the radius of the primary roller. This is advantageous since the adjustment of the radius of the primary roller can contribute to improve the printing results of the printing system. Further, when controlling the radius of the primary roller, the printing system can be used with packaging materials of different thicknesses as well as to compensate for differences in thickness throughout the web of packaging material used.

In one embodiment, there is provided a printing system wherein the at least one printing head has a fixed position relative a centre axis of the primary roller such that a distance L between the packaging material and the at least one printing head, in the radial direction of the primary roller, is adjusted by controlling the at least one heating element. This is advantageous since the adjustment of the radius of the primary roller can contribute to a constant distance L between the printing heads and the surface to be printed on the packaging material. This improves the printing results of the printing system.

In another embodiment, the printing system comprises a plurality of printing heads each having the same distance L between the packaging material and the printing head. The use of several printing heads is advantageous since it enables a multi-colour print. The equal distance L ensures a high quality printing result.

In one embodiment, the printing heads are arranged next to each other in a circumferential direction of the primary roller. In addition, each printing head may have a certain extension in the longitudinal direction of the primary roller.

In yet another embodiment, the optimal distance between printing heads is as close as possible and depends on what ink system and curing systems used. The optimal distance between printing heads is as close as possible to the surface to print and depends to the printing technology. This is advantageous in that uneven dot size enlargement in between colours is avoided. Further, long dwell time before curing/drying to avoid inter-colour bleeding is avoided.

In an embodiment, the printing head(s) is/are arranged at the end of the distance of which the primary roller guides the web of packaging material, preferably immediately before the packaging material is leaving the primary roller.

In a further embodiment, the web of packaging material is guided by the primary roller along a certain circumferential distance, wherein the circumferential distance used to guide the web of packaging material is less than the full circumference of the primary roller. The printing head(s) is/are preferably arranged at the beginning or in the centre, preferably somewhere close to the centre of the circumferential distance.

In one embodiment, the primary roller is made of a metal, such as aluminium or steel. The choice of metal is advantageous in that it has preferable properties, such as high thermal expansion coefficient. Specifically, aluminium and steel have favourable properties such as a high thermal expansion coefficient. In addition, aluminium has low density and suitable oxidation properties making it particularly suitable for the environment and application in the printing system of a filling machine.

In yet another embodiment, the primary roller further comprises a servo motor configured to control the speed of the primary roller. The servo motor is advantageous in that it provides the primary roller with a speed control and torque control. In addition, the servo motor provides the primary roller with a pull and brake function. The servo motor also aids in guiding and feeding the web of packaging material into the printing system.

In another embodiment, the printing further comprises a detecting unit. The detecting unit is advantageous in that it can reveal printing errors using colour-to-colour or colour-to-lc mark.

In one embodiment, the detecting unit is connected to an inline printing quality control system. This is advantageous since the control system can yield information on whether the distance L needs to be adjusted in order to secure high quality prints.

In a further embodiment, the at least one heating element is an infrared source. The infrared source is advantageous since it can provide heating energy in a simple, reliable, and well controlled manner, causing the radius of the primary roller to expand due to thermal expansion.

In one embodiment, the at least one heating element is an electrical heating element. The electrical heating source is advantageous since it can easily be controlled.

According to one embodiment, the at least one heating element is extending along the centre axis A, in the radial direction, circumventing the centre axis A of the primary roller, or a combination thereof. This is advantageous in that the heating elements may be spread in all parts of the primary roller, assisting in heating the primary roller. The heating can thus take place quickly and the radius of the primary roller may be adjusted fast and in a controlled manner.

In another embodiment, the primary roller comprises a plurality of heating elements, such as between two and twelve heating elements, such as between two and eight heating elements, such as between two and four heating elements. A plurality of heating elements are preferable since this enables quick heating of the primary roller and more detailed control of the heating process. Several heating elements further assist in spreading the heat evenly throughout the volume of the primary roller. The primary roller may further be of varying sizes, and thus requires different numbers of heating elements. Primary rollers of different materials may require different numbers of heating elements depending on the properties of that material.

In yet a further embodiment, the heating elements are arranged at an equal and/or non-equal distances along the centre axis A of the primary roller. This is advantageous in that the heating elements may be arranged so as to adapt the heat spreading throughout the volume of the primary roller.

According to another embodiment, the plurality of heating elements are arranged at equal and/or non-equal radial distances from the centre axis A of the primary roller. This is advantageous in that the heating elements may be arranged so as to adapt the heat spreading throughout the volume of the primary roller.

According to one embodiment, the printing system comprises at least one ‘cooling element. The cooling element is advantageous in that is may control the radius of the primary roller by cooling the primary roller, which will then decrease its radius due to thermal shrinkage.

In one embodiment, the cooling element is configured to guide a cooling fluid.

The cooling fluid is

advantageous in that is may flow through the primary roller. The temperature of the cooling fluid may be regulated to control the thermal shrinkage of the radius of the primary roller.

In another embodiment, the printing system further comprises a tension roller. This is advantageous in that the tension roller may smoothen variations in paper tensions and may act as a small paper buffer. This improves the possibility of high accurate, high quality prints.

In yet another embodiment, the printing system further comprises a second tension roller. A second tension roller may mitigate paper tensions even further.

In one embodiment, the printing system further comprises snipping rollers. The snipping rollers are advantageous since they are configured to initiate a web tension origin point.

In one embodiment, the printing system further comprises an ink drying zone. This is advantageous in that the print is allowed to set and dry before passing i.e. a second tension roller or exiting the printing system in the filling machine.

In one embodiment, the printing system further comprises an edge guide system. This is advantageous in that the edge guide system is configured to control the transversal position of the web of packaging material. By controlling the transversal positioning of the web of packaging material the printing heads are assisted to be able to discharge droplets of colouring substance at the correct predetermined position on the packaging material.

In a second aspect, there is provided a method for printing a web of packaging material in a filling machine. The method comprises guiding the web of packaging material along a surface of a primary roller, discharging a colouring substance from at least one printing head onto the web of packaging material as it is guided by the primary roller, and controlling the radius of the primary roller using at least one heating element comprised in the primary roller. This method is advantageous since it allows for in line adjustment of the radius of the primary roller, which can compensate for differences in thickness of the web of packaging material. The method allows the printing system of a filling machine to print different packaging materials and the printing quality can be held high even if the web of packaging material exhibits variations in thickness throughout itself. The method is simple to operate, and it requires no extra feature which takes up space in the printing system and the method is not more time consuming than using already existing printing systems for filling machines.

In one embodiment, the method further comprises controlling the at least one heating element to adjust the a distance between the packaging material and the at least one printing head, in the radial direction of the primary roller, wherein the at least one printing head has a fixed position relative a centre axis of the primary roller.

In another embodiment, the method further comprises guiding the web of packaging material by the primary roller along a certain circumferential distance, wherein the circumferential distance used to guide the web of packaging material is less than the full circumference of the primary roller, and arranging the printing head(s) at the beginning or in the centre, preferably somewhere close to the centre of the circumferential distance.

In a third aspect, there is provided a primary roller of a printing system used in a filling machine which comprises at least one heating element configured to heat the primary roller in order to control the radius of the primary roller. A primary roller where the radius may be controlled is advantageous in that the distance between the outer surface of the primary roller and the printing heads of the printing system may be regulated.

In a fourth aspect, there is provided the use of the primary roller in a printing system to be used in a filling machine. This is advantageous in that the printing system may compensate for packaging material of different thicknesses and/or variation in thickness within a specific packaging material.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a schematic view of a printing system according to an embodiment;

FIG. 2a is a schematic view of a primary roller of the printing system according to the embodiment shown in FIG. 1;

FIG. 2b shows a cross-sectional schematic view of the primary roller according to the embodiment of FIG. 2a;

FIG. 2c shows a cross-sectional schematic view of a primary roller according to another embodiment;

FIG. 3a shows a schematic view of a primary roller of the printing system according to one embodiment;

FIG. 3b shows a cross-sectional schematic view of the primary roller according to the embodiment of FIG. 3a;

FIG. 4a shows a schematic view of a primary roller of the printing system according to one embodiment;

FIG. 4b shows a cross-sectional schematic view of the primary roller according to the embodiment of FIG. 4a;

FIGS. 5a and 5b show schematic views of a primary roller according to further embodiments;

FIG. 6 is a schematic view of a printing system according to another embodiment; and

FIG. 7 is a schematic view of a method according to an embodiment.

### DETAILED DESCRIPTION

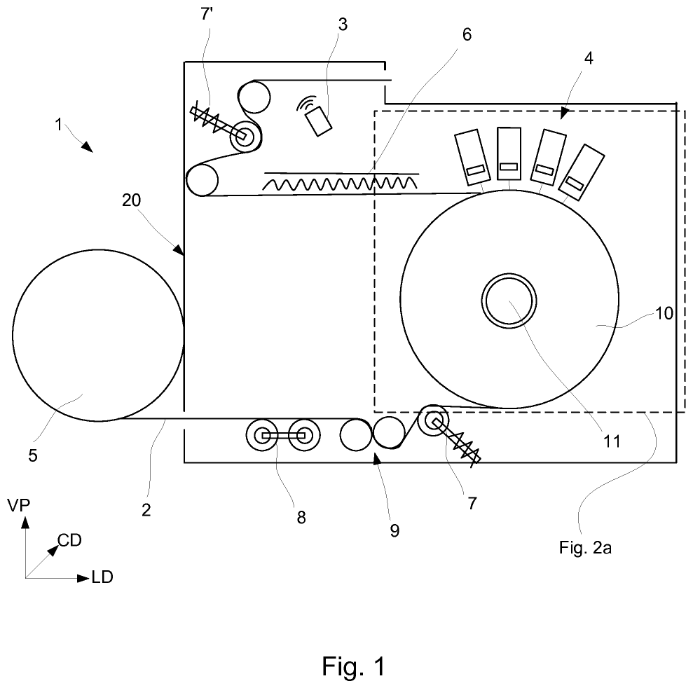

With reference to FIG. 1 a printing system 1 to be used in a filling machine 20 is illustrated. It should be noted that the reference 20 is to indicate only a small part of the filling machine, which also is provided with a sterilising unit, a tube forming unit, a filling unit, etc. which is already well known in the art.

The printing system 1 comprises a primary roller 10 and a set of printing heads 4. The primary roller 10 further comprises a servo motor 11 for driving the primary roller 10 to rotate.

In FIG. 1, a web of packaging material 2 has been fed to the printing system 1 inside the filling machine 20. The printing system 1 further comprises a set of snipping rollers 9. The web of packaging material 2 is supplied from a packaging material reel 5. An edge guide system 8 is also shown in FIG. 1, for ensuring the correct lateral position of the web of packaging material 2. An ink curing zone 6 is arranged downstream the printing heads 4, and a detecting unit 3 is also present which will be described further below.

The printing system 1 shown in FIG. 1 may further comprise a first and a second tension roller 7, 7′. The web of packaging material 2 is fed into the printing system 1 in a longitudinal direction LD, as indicated by the coordinate system in FIG. 1. The coordinate system also describes the transversal, or cross-wise, direction CD and the vertical direction VP of the packaging material 2.

The printing heads 4 have a fixed position relative the centre of the primary roller 10, such that they are arranged at a constant radius. Each of the printing heads 4 comprises a different colouring substance (not shown). The printing heads 4 are positioned next to each other. As an example, the printing heads 4 may be spaced apart by approximately between 5 and 20 mm, such as about 10 mm, and each printing head 4 may for instance have a width of approximately 40 mm.

The primary roller 10 is preferably made of a material having high thermal conductivity, such as a metal. Preferable metals to be used are aluminium or steel. The thermal expansion coefficient for aluminium is preferable for this application, as will be described further in the following. In addition, aluminium has low density and suitable oxidation properties.

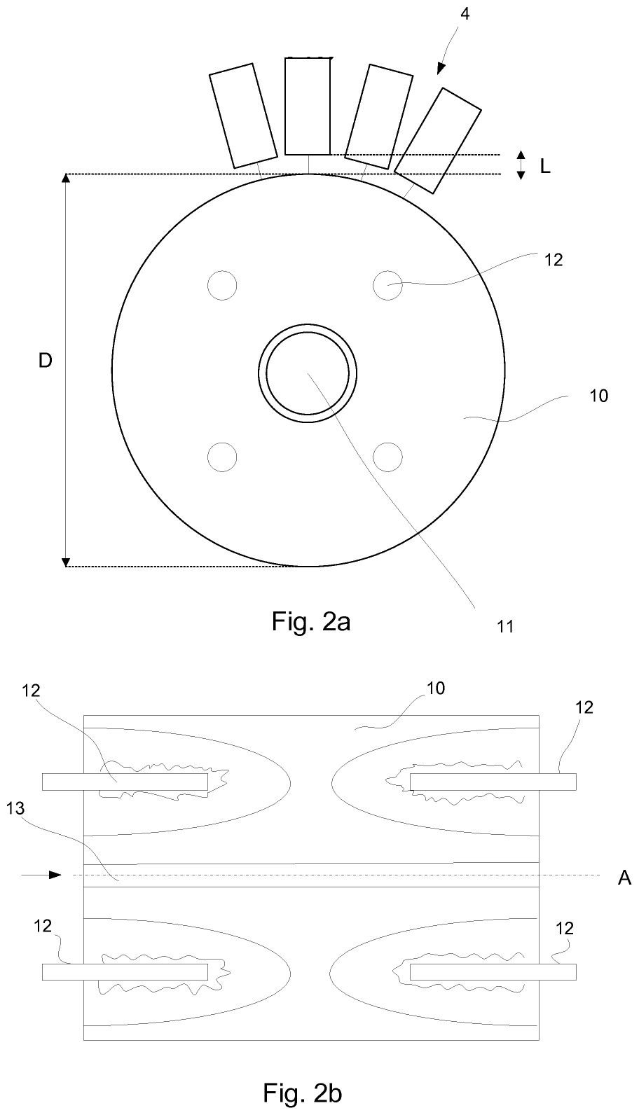

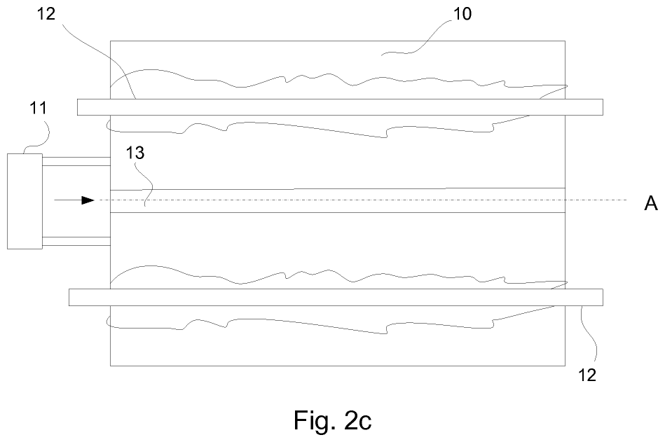

In FIG. 2a, an enlarged view of the primary roller 10 of FIG. 1 is shown. Four printing heads 4 are arranged vertically above the primary roller 10 and fixed relative the centre of said roller 10. The primary roller 10 further comprises four heating elements 12, which are all arranged at the same radial distance from a centre axis A of the primary roller 10 and spaced apart by approximately 90°. The primary roller 10 has a diameter D. An approximate standard diameter D of the primary roller may be about 400 mm. A normal distance L between the outer surface of the primary roller 10, and the discharge nozzle of the printing heads 4 facing the primary roller 10 is also shown.

In FIG. 2b, a cross-section along the centre axis A of the primary roller 10 of FIG. 2a is shown. The primary roller 10 comprises four heating elements 12 and a cooling element 13. The cooling element 13 may be a cooling fluid channel, guiding cooling fluid entering the primary roller 10 in the direction indicated by the arrow in FIG. 2b. However, the cooling element 13 may also be any other suitable cooling medium in solid, gaseous or liquid form.

The centre axis A shown in FIG. 2b is drawn as a dotted line through the entire primary roller 10. The heating elements 12 extend in parallel with the centre axis A and partly through the primary roller 10. The drawn blurred lines around each heating element 12 illustrates the radiation of heat from the elements 12. The geometric shape of half an ellipse surrounding each heating element 12 illustrates heat distribution throughout the primary roller 10. The heating elements 12 may also extend throughout the entire length of the primary roller 10, as shown in FIG. 2c. In this figure, an example of how to arrange the motor 11 is also shown.

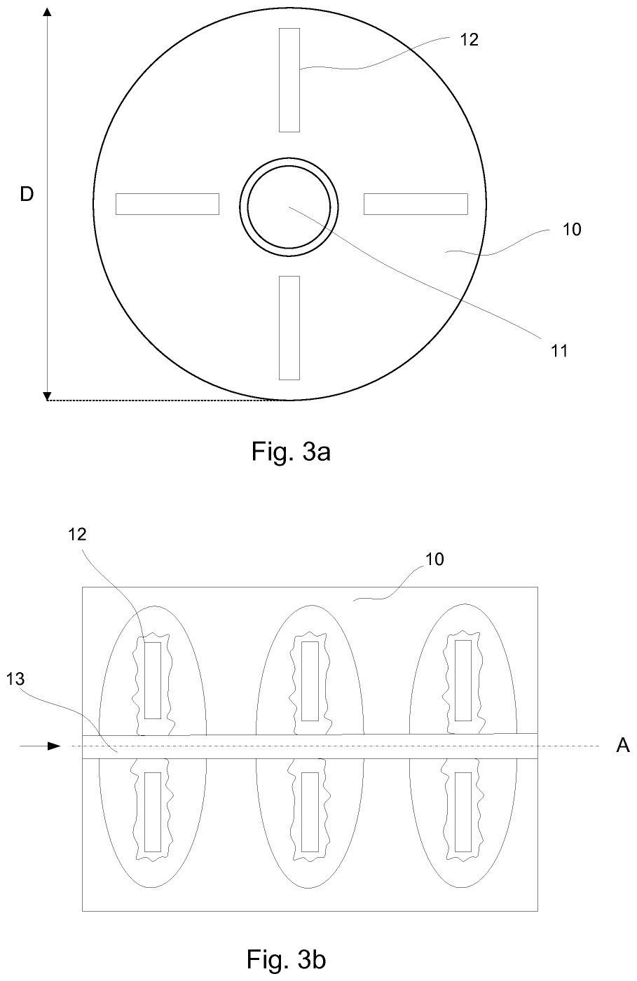

With reference to FIGS. 3a and 3b, a primary roller 10 according to another embodiment is shown. The primary roller 10 in FIG. 3a comprises four heating elements 12 extending radially from the centre axis A of the primary roller 10 towards the outer diameter of the primary roller 10. The cooling element 13 may be in any of the forms as described above.

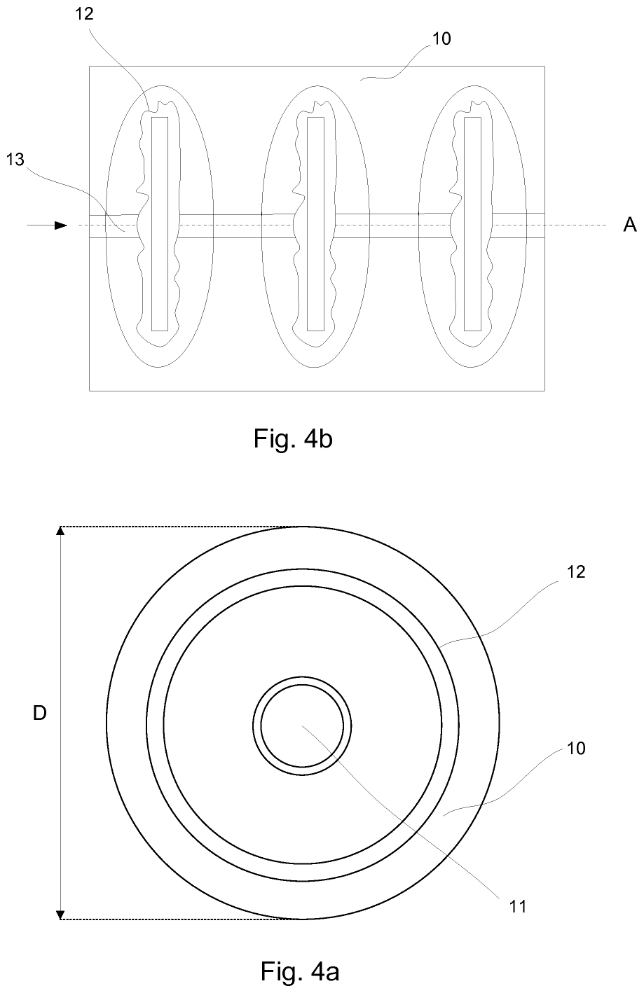

With reference to FIGS. 4a and 4b, a primary roller 10 according to yet another embodiment is shown. The heating element 12 circumvents the centre axis A of the primary roller 10 in FIG. 4a. FIG. 4b shows a side view of the cross-sectional view of the embodiment in FIG. 4a, to further illustrate the ring-shaped configuration of the heating element 12. The primary roller comprises three heating elements 12 arranged with a similar distance along the centre axis A in between them. In further embodiments, the primary roller 10 may comprise a plurality of heating elements 12 of different circumferences circumventing the centre axis A (not shown). The cooling element 13 may be in any of the forms as described above.

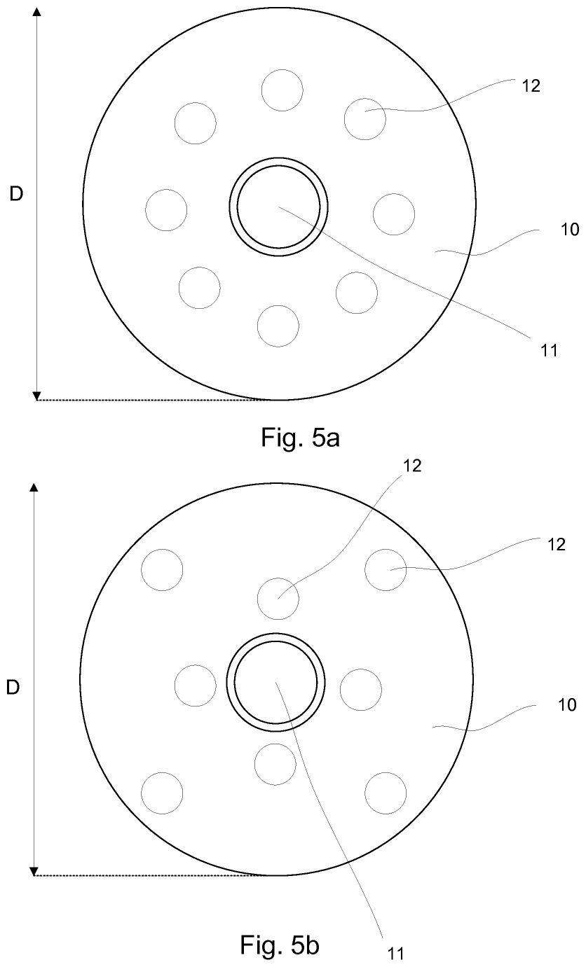

Further possible arrangements of the heating elements 12 in a primary roller 10 are shown in the embodiments of FIG. 5a and FIG. 5b. In FIG. 5a, the heating elements 12 are arranged evenly at a similar radial distance from the centre of the primary roller 10 and its outer surface. In FIG. 5b, four heating elements 12 are arranged closer to the centre of the primary roller 10 while four others are present closer to the outer surface of the primary roller 10.

The heating elements 12 may be arranged in several other ways not shown in the figures disclosed herein. For instance, the heating elements 12 may be arranged with equal or different distances between them along the direction of the centre axis A or in the radial direction between the centre and the outer diameter of the primary roller (not shown). The heating elements 12 may be of varying sizes and geometrical shapes (not shown). In addition, the heating elements 12 may extend not only linearly as shown in e.g. FIGS. 2b and 3b, but they may also extend in other configurations such as sinusoidal, in a zig zag or fish bone pattern or any other possible configuration enabling the distribution of heat throughout the primary roller 10. The primary roller 10 may comprise heating elements 12 arranged along the centre axis A, extending in the radial direction from the centre axis A, circumventing the centre axis A, or a combination thereof (not shown).

The heating element 12 may be for instance an infrared source, such as an infrared lamp. Furthermore, the heating element 12 may be an electrical heating element.

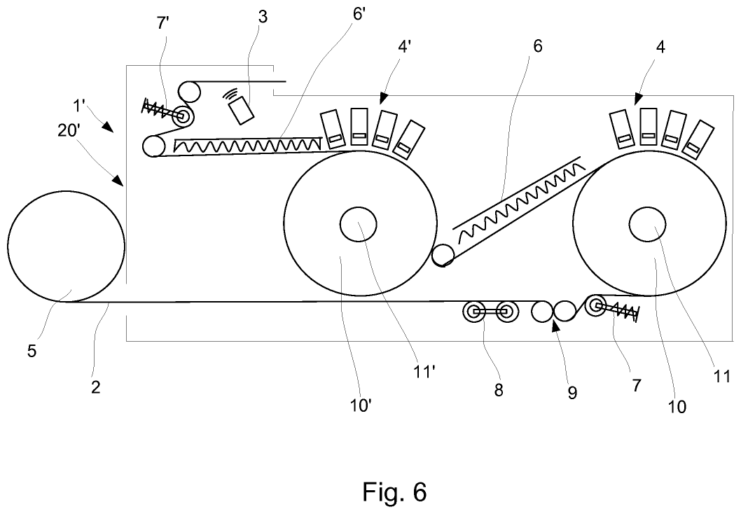

With reference to FIG. 6, another embodiment of a printing system 1′ to be used in a filling machine 20′ is shown. The printing system 1′ is based on modularity to solve the issue of using several extra colouring substances, and the system 1′ comprises a first primary roller 10 and a secondary primary roller 10′ and two sets of printing heads 4, 4′. Each primary roller 10, 10′ comprises a servo motor 11, 11′. The two sets of printing heads 4, 4′ are fixed relative a centre of the respective primary rollers 10, 10′. Each of the eight printing heads 4 may comprise a unique colouring substance (not shown).

In FIG. 6, the web of packaging material 2 is supplied from a packaging material reel 5. The printing system 1′ comprises an edge guiding system 8 and a set of snipping rollers 9. Downstream each primary roller 10, 10′, an ink curing zone 6, 6′ is provided. A detecting unit 3 is also arranged in the printing system 1′ downstream the second primary roller 10′ and its corresponding ink curing zone 6′. The printing system 1′ further comprises a first and a second tension roller 7, 7′.

Each primary roller 10, 10′ of the printing system 1′ in the embodiment shown in FIG. 6 comprises heating elements 12 and cooling elements 13 as described in the embodiments of FIGS. 2a-5b.

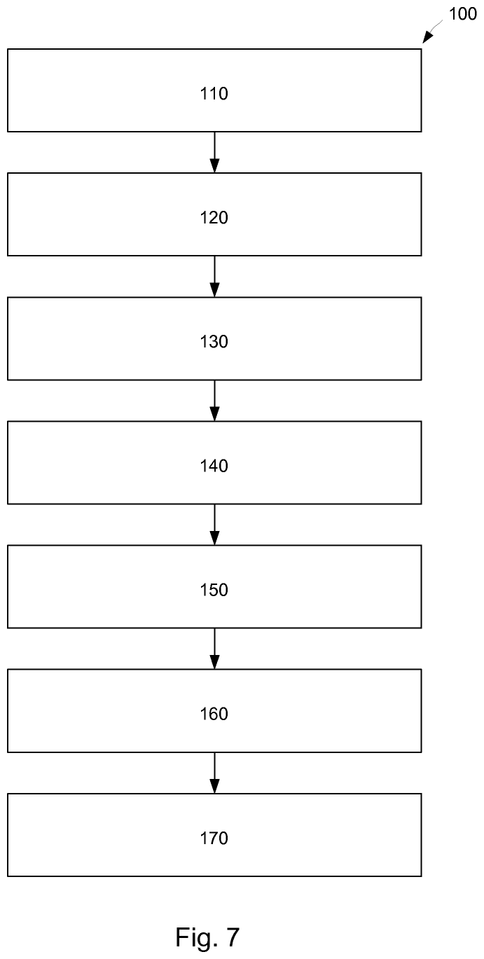

Before describing details of the printing system 1 to be used in a filling machine 20, a method 100 will be briefly described with reference to FIG. 7. When printing a web of packaging material 2 in a printing system 1 used in a filling machine 20, a number of steps are performed. Starting in step 110, the web of packaging material 2 is guided along a surface of the primary roller 10. A colouring substance is then discharged 120 from the printing heads 4 onto the web of packaging material 2 as it is guided 110 by the primary roller 10. The diameter D of the primary roller 10 is controlled 130 by at least one heating element 12 comprised in the primary roller 10. By increasing the temperature of the primary roller 10, the diameter will increase due to thermal expansion of the material of the primary roller 10. Thermal expansion is the tendency of materials to alter their shape, volume and are as a response to a change in temperature. When matter is heated, the kinetic energy of its molecules increases, causing the molecules to move more. This results in a higher average separation between the molecules, which in turn causes an expansion of the material. In the case of the primary roller 10, its diameter D will increase during heating and the diameter D will decrease when cooled. The adjustment of the diameter D of the primary roller 10 ensures a correct normal distance L between the printing heads 4 and the web of packaging material 2 placed on the outer surface of the primary roller 10.

The printing system 1 to be used in a filling machine 20 will now be described more in detail. When printing a web of packaging material 2 in a printing system 1 used in a filling machine 20, it is important that the normal distance between each of the printing heads 4 and the printing surface of the packaging material 2 is accurate and constant. In order to achieve successful high quality prints, the normal distance L between the each of the printing heads 4 and the surface of the packaging material 2 to be printed therefore has to be closely monitored and controlled.

Since the filling machine 20 operates at a very high speed, a small variation in the normal distance L can cause large implications for the printing result. Normally, the printing heads 4 are fixed relative the centre of the primary roller 10 causing the distance between the printing heads 4 and the outer surface of the primary roller 10 to be constant. If packaging materials 2 have variating thicknesses, or if the packaging material 2 itself has thickness variations, the distance L between the surface to be printed and the printing heads 4 will alter which causes printing errors.

Variations in packaging material thickness may be caused by several factors. Different packaging materials 2 may have different thicknesses. Further, variations can occur depending on the supply source, but also storage conditions such as temperature and humidity.

The inventors have found that improved printing quality can be achieved by inline controlling of the diameter of the primary roller 10. If the outer diameter D of the primary roller 10 can be adjusted during in line printing, the normal distance L can be kept constant and controlled to a preferred length using the concept of thermal expansion.

With reference to FIG. 1, the web of packaging material 2 is fed into the printing system 1 within the filling machine 20. The web of packaging material 2 is supplied from the packaging material reel 5. However, the web of packaging material 2 may be supplied from any another source (not shown). The packaging material 2 then passes an edge guiding system 8 and through a set of snipping rollers 9.

The edge guiding system 8 shown in FIG. 1 is configured to control the transversal position in the cross-wise direction CD of the web of packaging material 2. Another issue when printing packaging material 2 in a filling machine 20 is that the transversal position of the packaging material 2 may vary, which yields unsatisfying print results. The transversal position may be affected by for instance web tension in the packaging material 2 and roller alignments. Optionally, a second edge guiding system may be placed at the exit of the primary roller 10 to improve the precision of the transversal position (not shown).

The set of snipping rollers 9 initiate the web tension origin point of the printing system 1. Tension of the web of packaging material 2 is also important for the printing quality. Web tension can for instance affect the longitudinal position of the packaging material 2. A printing system 1 that has a controlled web tension on the packaging material 2 enables synchronized printing of all colouring substances which are deposited by the printing heads onto the packaging material 2.

After the web of packaging material 2 has passed through the snipping rollers 9, it passes a tension roller 7, shown in FIG. 1, which will mitigate variations in tension of the packaging material 2. The packaging material 2 is thereafter threaded onto the circumference of the outer surface of the primary roller 10. When the packaging material 2 is wrapped around the primary roller 10, the friction between the packaging material 2 and the primary roller 10 will prevent the packaging material 2 from sliding and will thus contribute to a fixed transversal position of the packaging material 2.

The servo motor 11 of the primary roller 10 controls the speed in which the packaging material 2 is guided through the printing system 1. In FIG. 1, the servo motor 11 causes the primary roller 10 to rotate around its own centre axis A, guiding the packaging material 2 around its outer circumferential surface towards the printing zone area beneath the printing heads 4.

When the packaging material 2 reaches the printing zone area beneath the printing heads 4, one colouring substance can be deposited from each one of the printing heads 4 onto the packaging material 2 at a predetermined position.

As shown in FIG. 1, the printing heads 4 are typically arranged in line between each other perpendicular to the center axis A of the primary roller 10. The normal distance L between the surface of the packaging material 2 and the printing head 4 is preferably the same for each of all the printing heads 4.

The web of packaging material 2 will continue to travel downstream to the ink curing zone 6 where the printed pattern is set. After the printed pattern has set, the web of packaging material 2 passes a detecting unit 3.

The detecting unit 3 may be connected to an inline printing quality control system, which may be a feedback system, such as a PID close loop system. The detecting unit 3 detects the printing quality on the packaging material 2, for example in terms of position, quality, etc. The detecting unit 3 will provide information on whether adjustments of the diameter D of the primary roller 10 is needed, and such information is then forwarded to a control unit (not shown) being configured to control the heating elements 12 and the cooling element 13.

The now readily printed packaging material 2 is then fed out of the printing system 1 and to further stations of the filling machine 20.

Again, with reference to FIG. 2a, each of the printing heads 4 have a fixed position relative the centre axis A of the primary roller 10. The normal distance L between the printing surface of the packaging material 2 of the primary roller 10 and each printing head 4 may be adjusted. This is accomplished by altering the diameter D of the primary roller 10 through thermal expansion or shrinking. Since each of the printing heads 4 are fixed relative the centre axis A of the primary roller 10, the normal distance L between the printing surface and the edge (i.e. the nozzles of the printing head) of each of the printing heads 4 facing the primary roller 10 is adjusted when the diameter D of the primary roller 10 is increased or decreased. In this way, the distance between the packaging material 2 and the printing heads 4 can be controlled.

The detecting unit 3 shown in FIG. 1 can give information on whether the distance L needs to be adjusted. An increase of the diameter D of the primary roller 10 is obtained by heating the primary roller 10 using the at least one heating element 12 shown in for instance FIG. 2a. Heating will cause the primary roller 10 to increase its diameter D due to thermal expansion. The requested variation of the diameter D should preferably correspond to the difference in material thicknesses of the web of packaging material 2. Possible packaging material thicknesses may typically vary by up to approximately 0.5 mm. Thus, to compensate for such thickness variation, a variation of the radius of the primary roller 10 may for example be between 0.7 and 0.3 mm, more preferably between 0.6 and 0.4 mm and most preferred about 0.5 mm (a variation of the radius of about 0.5 mm resulting in a variation of the diameter D of the primary roller 10 of approximately 1 mm).

The normal distance L between the primary roller 10 and the printing heads 4 is approximately 3 mm during operation.

Typically, the environment in the printing system 1 inside the filling machine 20 is humid. This can be an issue since humidity may cause condensation to form in or on the packaging material 2, which affects the packaging material 2 negatively. However, for the printing system 1 disclosed herein, the temperature on the outer surface of the primary roller 10 is preferably kept above the dew point (approximately 14-16° C.). Thus, condensation will not form and the problem of condensation influencing the packaging material 2 is avoided. An ambient packaging material temperature may be approximately 20° C. and a maximum packaging material temperature may be approximately 70° C.

Again, with reference to FIG. 6, in multi-colour printing, it may be difficult to handle several colours at the same time since each colour substance require a separate printing head 4. To print e.g. eight colour substances, using for instance CMYK (Cyan, Magenta, Yellow and Black) together with four additional colours (such as OGV+, being Orange, Green, Violet and white/grey/blue) a primary roller 10 of a very large diameter is required to fit all eight printing heads 4 and the printing system 1 would be difficult to operate. However, in FIG. 6, two different primary rollers 10, 10′ are used in the printing system 1′. The primary rollers 10, 10′ and the other components of the printing system 1 shown in FIG. 6 are configured in the same way as in the printing system 1 described above. If even further colouring substances are to be used, additional primary rollers may be added to the printing system 1′ (not shown).

From the description above follows that, although various embodiments of the invention have been described and shown, the invention is not restricted thereto, but may also be embodied in other ways within the scope of the subject-matter defined in the following claims.

1. A printing system to be used in a filling machine (20) for printing to a web of packaging material (2), comprising:
a primary roller (10) configured to guide the web of packaging material (2) along its surface, and
at least one printing head (4) configured to discharge a colouring substance onto the web of packaging material (2) as it is guided by the primary roller (10),
wherein
the primary roller (10) comprises at least one heating element (12) for controlling the radius of the primary roller (10) using the principle of thermal expansion.

2. The printing system (1) according to claim 1, wherein the at least one printing head (4) has a fixed position relative a centre axis (A) of the primary roller (10), such that a distance (L) between the packaging material (2) and the at least one printing head (4), in the radial direction of the primary roller (10), is adjusted by controlling the at least one heating element (12).

3. The printing system (1) according to claim 1 or 2, wherein the printing system (1) comprises a plurality of printing heads (4) each having the same distance (L) between the packaging material (2) and the printing head (4).

4. The printing system (1) according to claim 3, wherein the printing heads (4) are arranged next to each other in a direction perpendicular to the centre axis (A) of the primary roller (10).

5. The printing system (1) according to any one of the preceding claims, wherein the web of packaging material (2) is guided by the primary roller (10) along a certain circumferential distance, wherein the circumferential distance used to guide the web of packaging (2) material is less than the full circumference of the primary roller, and wherein the printing head(s) (4) is/are arranged at the beginning or in the centre, preferably somewhere close to the centre of the circumferential distance.

6. The printing system (1) according to any one of claims 1 to 4, wherein the printing head(s) (4) is/are arranged at the beginning or middle, preferably the middle, of the distance of which the primary roller (10) guides the web of packaging material (2).

7. The printing system (1) according to any one of the preceding claims, wherein the primary roller (10) is made of a metal, preferably aluminium or steel.

8. The printing system (1) according to any one of the preceding claims, wherein the primary roller (10) further comprises a servo motor (11) configured to control the speed of the primary roller (10).

9. The printing system (1) according to any one of the preceding claims, further comprising a detecting unit (3).

10. The printing system (1) according to any one of the preceding claims, wherein the at least one heating element (12) is an infrared source.

11. The printing system (1) according to any one of the preceding claims, wherein the at least one heating element (12) is an electrical heating element.

12. The printing system (1) according to any one of the preceding claims, wherein the at least one heating element (12) is: extending along the centre axis (A), extending in the radial direction, circumventing the centre axis (A) of the primary roller (10), or a combination thereof.

13. The printing system (1) according to any one of the preceding claims, wherein the primary roller (10) comprises a plurality of heating elements (12), such as between two and twelve heating elements (12), such as between two and eight heating elements (12), such as between two and four heating elements (12).

14. The printing system (1) according to claim 13, wherein the plurality of heating elements (12) are arranged at equal and/or non-equal distances along the centre axis (A) of the primary roller (10).

15. The printing system (1) according to claim 13, wherein the plurality of heating elements (12) are arranged at an equal and/or non-equal radial distance from the centre axis (A) of the primary roller (10).

16. A method (100) for printing a web of packaging material (2) in a filling machine (20), the method comprising:
guiding (110) the web of packaging material (2) along a surface of a primary roller (10),
discharging (120) a colouring substance from at least one printing head (4) onto the web of packaging material (2) as it is guided by the primary roller (10), and
controlling (130) the radius of the primary roller (10) using at least one heating element (12) comprised in the primary roller (10).

17. A primary roller of a printing system (1) used in a filling machine (20) comprising at least one heating element (12) configured to heat the primary roller (10) in order to control the radius of the primary roller (10).

18. Use of the primary roller (10) according to claim 17 in a printing system (1) to be used in a filling machine (20).
